(19) United States
(12) Patent Application Publication
(10) Pub. No.: US 2020/0269486 A1
(43) Pub. Date: Aug. 27, 2020

(54) APPARATUS FOR MAKING DENTAL APPLIANCES

(71) Applicant: Volker DREVE, Unna (DE)

(72) Inventor: Volker DREVE, Unna (DE)

(21) Appl. No.: 16/750,108

(22) Filed: Jan. 23, 2020

(30) Foreign Application Priority Data
Feb. 25, 2019 (DE) 202019101071.1

(51) Int. Cl. B29C 51/10; A61C 5/00; B29L 31/00

(52) U.S. Cl. CPC B29C 51/10; B29L 2031/753; A61C 5/007

(57) ABSTRACT

An apparatus for making dental splints has a model plate forming a plurality of model-placement areas each having an upper face adapted to support a respective dental model and a lower face. Each area is formed with an opening between the respective faces, and respective conduits are connected to the lower faces of the areas at the openings. A rack for holding a thermoshapable film is movable between a position spaced from the plate and a position over the plate with the film engaging an outer edge of the plate all around the placement areas atop the plate over the models thereon. A pump or the like generates a subatmospheric pressure and applies it via the conduits to the placement areas to draw the film down over the models.

### FIELD OF THE INVENTION

The present invention relates to an apparatus for making dental appliances. More particularly this invention concerns dental splints, mouth guards, or braces.

### BACKGROUND OF THE INVENTION

Parts intended for dental purposes, in particular mouth-worn splints for a dentate upper or lower jaw are typically made by deep-drawing. To this a model of the patients dentition is inserted into the apparatus, a thermoshapable film being placed on the model and deep-drawn to form a splint by a vacuum generator.

Such an apparatus is known in the prior art. Individual appliances intended for dental purposes are manufactured in such an apparatus. A model is placed onto a model space. A thermoshapable film is positioned over the model, sealed in a suitable manner, and then introduced into the apparatus. The thermoshapable film is then heated and shaped onto the respective model using a vacuum generator so that it assumes the shape of the model. After cooling, the apparatus can then be opened and the molded thermoshapable film removed together with the model as appropriate.

While such an apparatus is indeed usable and can also be used for many purposes, there is a need for the ability to manufacture such thermoshaped products as quickly as possible, which is not the case with the conventional known apparatus, since only one splint or the like can be produced with each cycle.

### OBJECTS OF THE INVENTION

It is therefore an object of the present invention to provide an improved apparatus for making dental appliances.

Another object is the provision of such an improved apparatus for making dental appliances that overcomes the above-given disadvantages, in particular that allows the appliances to be made in groups, thereby reducing the production costs for such appliances.

### SUMMARY OF THE INVENTION

An apparatus for making dental splints has according to the invention a model plate forming a plurality of model-placement areas each having an upper face adapted to support a respective dental model and a lower face. Each area is formed with an opening between the respective faces, and respective conduits are connected to the lower faces of the areas at the openings. A rack for holding a thermoshapable film is movable between a position spaced from the plate and a position over the plate with the film engaging an outer edge of the plate all around the placement areas atop the plate over the models thereon. A pump or the like generates a subatmospheric pressure and applies it via the conduits to the placement areas to draw the film down over the models.

According to such a design, the apparatus is not only provided not with a single a model placement area, but with a plurality of model placement areas that are formed on the model plate. In order to enable a plurality of parts intended for dental purposes to be manufactured at the same time by deep-drawing thermoshapable films, each model placement area is equipped on its underside with a connection to the vacuum generator opposite the area that is used to arrange a model, which vacuum generator, in turn, opens out via connecting channels or slots on the upper side of the respective model placement area. This makes it possible, on the one hand, to connect the vacuum generator to all of the model placement areas on the underside and thus to create a vacuum in any desired region. On the other hand, the necessary connection between the vacuum generator and the placement area is established via the connecting channels or slots on the upper side of the respective model placement area.

In addition, a rack for a thermoshapable film is provided above the model plate and covers all of the model placement areas. It is thus possible to place and position only a single thermoshapable film so that the thermoshaping process can then be carried out simultaneously in all of the model placement areas. In order to enable the thermoshapable film to be put in place, the rack for the thermoshapable film can be moved into a handling position in which it is at a spacing from the model placement areas, so that the thermoshapable film can be inserted into it without being obstructed by the models on the model placement areas.

Furthermore, the rack can be moved into a working position from which it is lowered onto the models located in the model placement areas and rests in an airtight manner at least against the outer edge of the model plate in order to achieve tightness when a vacuum is applied. This apparatus thus makes it possible in a simple manner to manufacture a large number of parts intended for dental purposes at the same time by deep-drawing a single sheet of the thermoshapable film. The total time expenditure is substantially reduced compared to conventional technology, resulting in a substantial reduction in product prices. A busy orthodontist, for instance, can make a batch of appliances as soon as all of the placement areas are full.

In a special development, the vacuum generator is connected to the connecting channels or slots via hoses, with all of the hoses having the same length and the same cross section or diameter.

This ensures that the vacuum generator in the form of a powerful vacuum pump is connected to the connecting channels or slots by appropriate hoses, so that all suction points can be evacuated simultaneously and uniformly, provided that the vacuum is built up using the vacuum generator.

In order to simultaneously manufacture the corresponding products in a single work step, it is extremely helpful and necessary that the individual suction points be equipped with vacuum conduits that have the same length and the same diameter or cross sections.

In another preferred embodiment, the rack for the thermoshapable film is formed by a film cassette with a frame-like upper part and a frame-like lower part. The upper part can be moved relative to the lower part into a handling position in which a thermoshapable film can be placed without constraint between upper and lower part. The film is then clamped between the upper and lower part in an intermediate position and can be or is pushed into a insertion part of the cassette in this intermediate position, in which insertion part the upper part together with thermoshapable film and lower part are held in the working position in a tensioned state.

This provides an especially practical work aid. The film cassette has a simple film holder that can be removed from the apparatus and is formed by the frame-like upper part and the frame-like lower part. This part can be removed for the purpose of loading and removing the thermoshapable films, and the upper part can be detached from the lower part, so that on the one hand it is possible to insert a thermoshapable film and on the other hand it is possible to remove the reshaped thermoshapable film together with models upon completion of the work process.

Especially preferably, the insertion part of the cassette has pressure distribution strips that are supported marginally on the edge of the upper part parallel to the direction of insertion of the package consisting of the upper part, thermoshapable film, and lower part.

This makes it possible for the cassette and, in particular, the thermoshapable film to be fixed by the pressure distribution strips when it is pushed into the apparatus in such a way that the necessary tension is ensured even in the event of different material thicknesses of the thermoshapable film.

For this purpose that the pressure distribution strips are elastically compressible transverse to the direction of insertion.

According to this embodiment, it is of course also possible for the film cassette to not only be inserted into the apparatus with the thermoshapable film, in which case the thermoshapable film can simply be mounted in the film cassette, but rather it can also be removed together with the thermoshapable film and the models located thereon that adhered during reshaping upon conclusion of the thermoshaping process, thereby facilitating and accelerating the work in this regard as well.

In an inherently known manner, the apparatus has a heat source for heating the thermoshapable film, preferably a heater above each model placement area.

In addition, especially preferably the model placement areas on the model plate are arrayed in a plurality of rows and columns.

This arrangement is especially auspicious with respect to the corresponding connection requirements, it being possible, for example, to arrange three model placement areas in a plurality of rows that are oriented parallel to one another and thus also form, for example, three model placement areas in three columns that are spaced apart equidistantly from one another.

### BRIEF DESCRIPTION OF THE DRAWING

The above and other objects, features, and advantages will become more readily apparent from the following description, reference being made to the accompanying drawing in which:

FIG. 1 is a perspective view of part of the apparatus;

FIG. 2 is a schematic view of further elements of this invention; and

FIG. 3 is an exploded view of more elements of the invention.

### SPECIFIC DESCRIPTION OF THE INVENTION

The details shown in the drawing are components of an apparatus for making parts intended for dental purposes, in particular mouth-worn splints for dentate upper or lower jaws, by thermoshaping. A model is usually placed into the apparatus and a thermoshapable film is placed on the model. This thermoshapable film is deep-drawn by a vacuum generator to form a splint, the thermoshapable film being preferably heated in order to facilitate and accelerate the thermoshaping process.

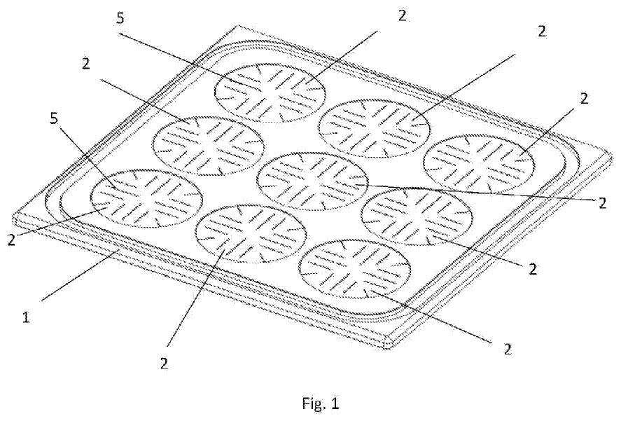

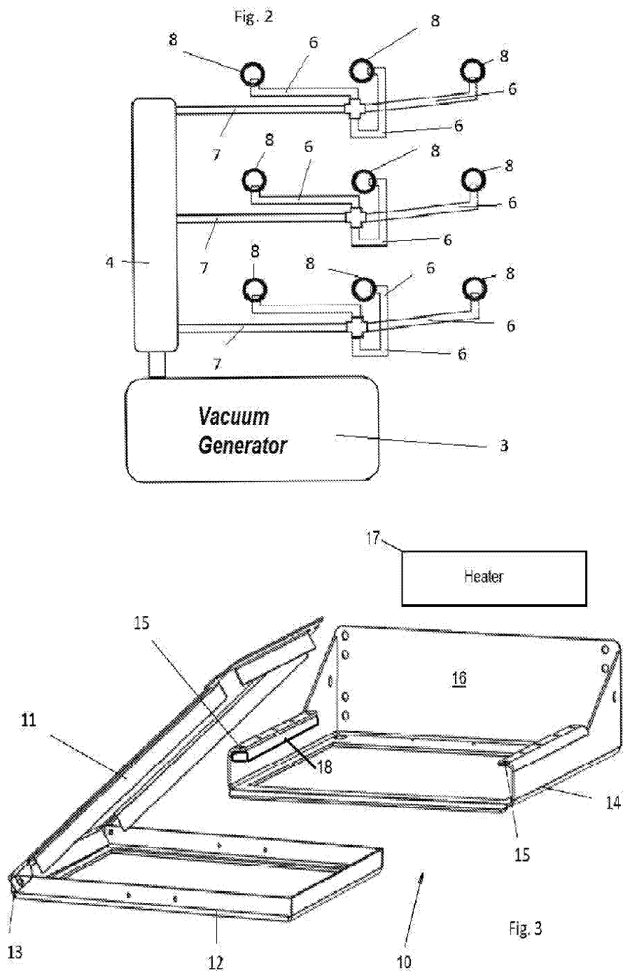

The apparatus has a model plate 1 forming an array of model placement areas 2. Each model placement area 2 has a connection to a vacuum generator 3 (see FIG. 2) on its underside opposite the upper face that is supports a respective model. The vacuum generator 3 is connected to the model placement areas by a manifold 4 and additional elements, each model placement area having connection slots 5 that open out on the upper face. A rack for a roll of thermoshapable film is provided above the model plate 1 and covers all of the model placement areas 2. This can be moved into a handling position in which it is at a spacing from the model placement areas 2, as well as into a working position in which it can be lowered onto the models located in the model placement areas 2 and rests in an airtight manner at least against the outer edge of the model plate 1. In particular, the vacuum generator 3 is connected to the connecting channels or slots 5 via the manifold 4 and additional conduits including a supply line 7 and respective hoses 6 having the same length and the same cross section or diameter. This ensures that when the vacuum generator 3 is started up, each connection fitting 8 can exert suction in the same way and with the same power through the slots 5 of the model placement areas 2 on the thermoshapable film above it.

The actual rack for the thermoshapable film is formed by a film cassette 10 (FIG. 3) having has a frame-like upper part 11 and a frame-like lower part 12. The upper part 11 is connected to the lower part 12 via a hinge 13, so that the upper part can be moved relative to the lower part into a handling position as shown in FIG. 3. In this position, a thermoshapable film can be placed without constraint between the upper part and part 11 and 12. The upper part 11 can then be pivoted down onto the lower part 12, so that the thermoshapable film is clamped between these parts 11 and 12. The clamping takes place at the outer edges of the upper part and lower part 11, 12.

In this so-called intermediate position, the film cassette can be pushed into an insertion part 14 of the overall cassette construction, for which purpose the insertion part has an insertion guide 15 on one side and a stop 16 on the rear side that limits the insertion depth of the parts 11 and 12 into the cassette 10.

In a working position, the upper part 11 together with the thermoshapable film and the lower part 12 are held in the insertion part 14 in a planar and taut state. In the inserted position, the insertion parts 11 and 12 of the cassette are held in the U-section guide 15 on the upper part 11, whereby the elements are held with the necessary tension even in the event of different material thicknesses of the film. Unillustrated pressure distribution bars 18 are provided on the guide 15. The pressure distribution strips 18 are preferably arranged so as to be resiliently flexible transverse to the direction of insertion.

In an inherently known manner, such an apparatus also has a heat source 17 for heating the thermoshapable film located in the desired position, it being preferred for a plurality of heat sources, especially preferably one heat source, to be arranged above each model placement area 2.

As can be seen in FIG. 1 in particular, the model placement areas 2 are arranged and formed on the model plate 1 in a plurality, here three rows and columns.

The invention makes it possible in a simple manner to manufacture multiple splints simultaneously through deep drawing on a plurality of models. Upon conclusion of the thermoshaping process, the cassette 10 can be removed and handled together with the thermoshapable film and models located thereon, it being possible for the thermoshapable film to be removed and the splints separated from the film together with model.

The invention is not limited to the embodiment, but rather can be varied in many respects within the framework of the disclosure.

All of the novel individual and combined features disclosed in the description and/or drawing are regarded as being essential to the invention.

I claim:

1. An apparatus for making dental splints, the apparatus comprising:
a model plate forming a plurality of model-placement areas each having an upper face adapted to support a respective dental model and a lower face, each of the areas being formed with an opening between the respective faces;
respective conduits connected to the lower faces of the areas at the openings;
a rack for holding a thermoshapable film and movable between a position spaced from the plate and a position over the plate with the film engaging an outer edge of the plate all around the placement areas atop the plate over the models thereon; and
means for generating a subatmospheric pressure and applying it via the conduits to the placement areas to draw the film down over the models.

2. The splint-making apparatus according to claim 1, wherein the conduits extend between the means and the areas are all of substantially same length and flow cross section so as to equally depressurize the areas under the film.

3. The splint-making apparatus according to claim 1, wherein the rack has
a lower frame part;
an upper frame part fittable with the lower frame part;
a hinge between the parts for pivoting of same together into a closed position gripping the film and an open position for releasing the film; and
a guide into which the upper and lower parts can fit in the closed position.

4. The splint-making apparatus according to claim 3, wherein the guide includes strips for pressing down the parts when fitted therein.

5. The splint-making apparatus according to claim 4, wherein the strips are elastically compressible.

6. The splint-making apparatus according to claim 1, further comprising:
a heater above the plate for softening the film.

7. The splint-making apparatus according to claim 1, wherein the areas are ordered in rows an columns.
